(19) United States
(12) Patent Application Publication
(10) Pub. No.: US 2020/0051139 A1
(43) Pub. Date: Feb. 13, 2020

(54) SYSTEMS AND METHODS FOR REVIEWING A PRODUCT OR SERVICE

(71) Applicant: Medical Justice Corp., Greensboro, NC (US)

(72) Inventor: Jeffrey J. Segal, Greensboro, NC (US)

(21) Appl. No.: 16/101,776

(22) Filed: Aug. 13, 2018

(51) Int. Cl. G06Q 30/02; H04L 12/58; G06F 17/30; G06F 9/54

(52) U.S. Cl. CPC G06Q 30/0282; H04L 51/08; H04L 51/38; G06F 9/543; G06F 17/30882

(57) ABSTRACT

A method of reviewing a product or service includes receiving user input from a first device, the input comprising a review of the product or service, storing the user input, and causing execution of a script on a second device. The script is configured to retrieve the user input and store it in a clipboard of the second device. A system for carrying out the method may present the survey to the patient on a kiosk, or on a desktop, laptop or tablet computer.

### FIELD OF THE INVENTION

This invention relates to systems and methods for reviewing products or services where an input device having an easily usable text input method is provided at point-of-sale or point-of-service, while the final submission of the review is performed on a different device.

### BACKGROUND OF THE INVENTION

Many service providers and retail locations request that customers review a product or service he or she has purchased. Product and service providers may desire survey responses to be posted to review platforms in order to increase public awareness and/or market visibility of their products or services; to provide feedback for quality improvement; or both. Often, a device is provided for the customer to enter information, take a survey, and/or respond to various questions relating to the product or service. However, the provided device is meant for public use and is therefore not connected to any of the customer's personal accounts on various platforms where the review may be posted. Such platforms may not permit anonymous reviews to be posted. Thus, existing systems require that the user reenter his or her survey or review responses on a review platform. Many users would prefer not to complete a survey or review twice, resulting in very few surveys or reviews being posted on review platforms. Additionally, service providers and retailers would prefer customers to complete surveys and reviews on site, while customer experiences are still fresh, and before other activities interfere with customers' completion of the survey or review.

### SUMMARY OF THE INVENTION

The present invention allows a user to fill out a survey and/or provide a review at the point-of-sale or point-of-service using a first device, and submit the survey or review to a review platform from a second device which may be linked to the user's account on the review platform, allowing the survey or review to be posted on the review platform. Additionally, the present invention allows the survey or review to be submitted to the review platform without requiring the user to reenter the user's answers to the survey or review.

According to embodiments of the invention, a user uses a first device provided at the point-of-sale or point-of-service location to complete a survey or review of the product or service. The first device may have an input method that is simple to use and offers convenience to the user when entering long strings of text, such as may be entered in response to certain questions of the survey or review. When finished, the user submits the survey or review using a submission mechanism provided on the first device.

The submitted survey or review is transmitted to a server. The server stores the survey or review, either temporarily or in long-term storage. The survey or review may include identifying information associated with the user, such as an email address or telephone number. The server may store the survey or review in association with the identifying information, allowing retrieval of the survey or review based on the identifying information.

The user is prompted to access the survey or review in order to post the survey or review on a review platform or website. The prompt may be a link to a review platform or website, and may be sent to the user based on the identifying information. The link may be contained within an SMS message, an MMS message, or an email. Upon following the link, the server causes execution of a script on the second device. The second device may be associated with the identifying information, and the script may be directed to the second device using the identifying information. The script is configured to cause the second device to retrieve the survey or review from the server and store it in a clipboard of the second device. Once stored in the clipboard, the user may use a “paste” function of the second device to copy the content of the survey or review stored in the clipboard of the second device into the review platform or website.

Therefore, in accordance with the present invention, there is provided a method of reviewing a product or service. The method includes receiving user input from a first device, the user input comprising a review of the product or service; storing, in a memory, the user input; and causing execution of a script on a second device, the script being configured to retrieve, from the memory, the user input, and store the user input in a clipboard of the second device.

There is also provided a system for administering such a method, including memory configured to store reviews of the product or service, a first device that accepts user input comprising a review of the product or service, first control circuitry configured to receive the user input from the first device and store, in the memory, the user input, and second control circuitry configured to cause execution of a script on a second device, the script being configured to retrieve, from the memory, the user input, and store the user input in a clipboard of the second device.

### BRIEF DESCRIPTION OF THE DRAWINGS

The above and other advantages of the invention will be apparent upon consideration of the following detailed description, taken in conjunction with the accompanying drawings, in which like reference characters refer to like parts throughout, and in which:

FIG. 1 is a diagram of a review system in accordance with some embodiments of the invention;

FIGS. 2 and 3 are diagrams of messages transmitted to a second device in accordance with some embodiments of the invention; and

FIG. 4 is a flowchart representing a process for reviewing a product or service in accordance with some embodiments of the invention.

### DETAILED DESCRIPTION OF THE INVENTION

As noted above, according to embodiments of the invention, a user may use a first device provided at the point-of-sale or point-of-service location to complete a survey or review of the product or service. While one of ordinary skill in the art will recognize that the it may be used in any point-of-sale or point-of-service location, the present invention will be described below in the context of a medical office.

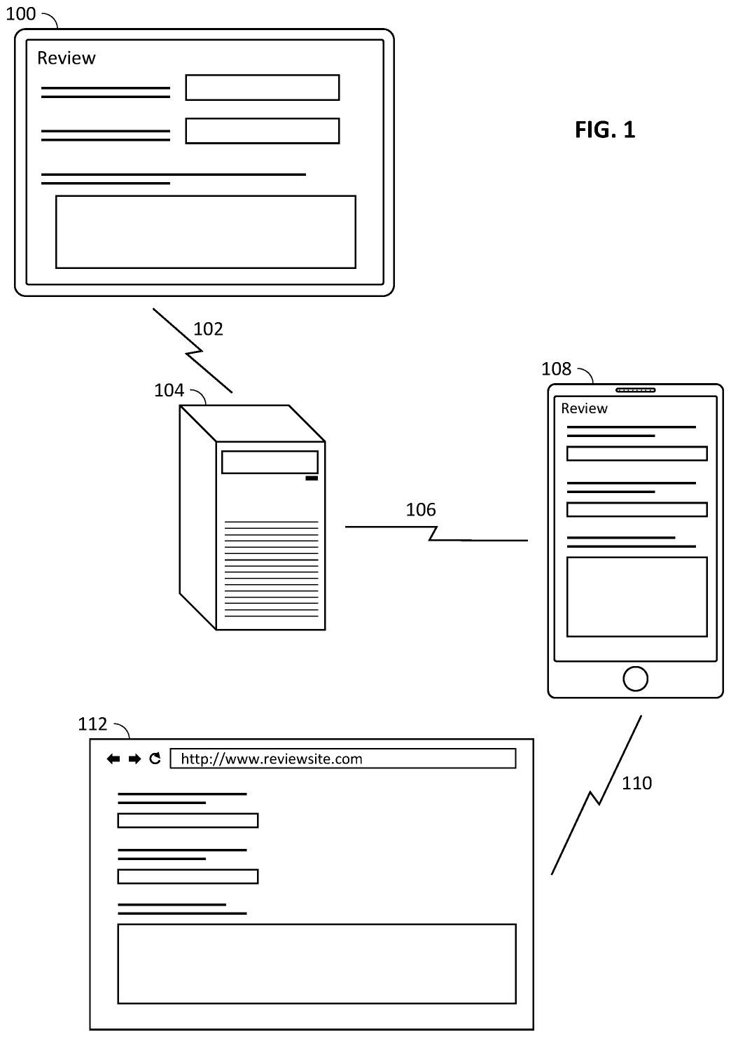

For example, a user may visit a medical office. At the conclusion of the user's visit, the user may be asked to complete a survey or review of the medical office, a specific doctor, and/or the care provided during the user's visit. FIG. 1 shows a diagram of a review system in accordance with some embodiments of the invention. The user may complete the survey or review using device 100. Device 100 may be a personal computer, tablet, or other suitable device. Device 100 may have an input method or input interface that is easy to use for entering long strings of text in response to survey questions, or in entering detailed information in a review. For example, a personal computer may have a physical keyboard for accepting user input, and a tablet may have a large on-screen virtual keyboard. The survey or review may include several questions, including yes/no questions, questions in which the user is asked to rate their experience on a numerical scale, and open questions in response to which the user is permitted to enter free text. When finished, the user may submit the survey or review using a submission mechanism provided on the first device. The submitted survey or review may be transmitted 102 to a server 104. The server 104 may store the survey or review, temporarily or in long-term storage.

In addition to questions relating to the user's experience at the medical office, the survey or review may ask for identifying information associated with the user, such as an email address or telephone number. The server 104 may store the survey or review in association with the identifying information, allowing retrieval of the survey or review based on the identifying information. For example, the survey or review may be stored in a database. In some embodiments, the identifying information may be stored in a separate database field, which may facilitate retrieval of the survey or review based on the identifying information by using, for example, an SQL “SELECT” command. For example, the identifying information may be the mobile telephone number (914) 555-0123. The survey or review may then be retrieved using the command “SELECT*FROM reviews WHERE identification IS ‘(914) 555-0123’”. Other suitable database retrieval methods may also be used.

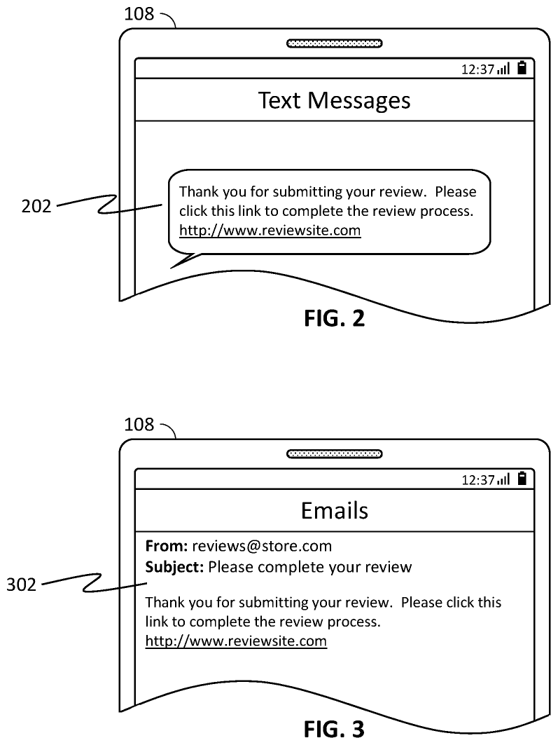

The server 104 causes execution of a script on the second device 108 to retrieve 106 the survey or review and store it in a clipboard of the second device, for example, as follows. The second device is associated with the identifying information, and the server 104 transmits a message to the second device 108 based on the identifying information. The message contains a link to complete the survey or review process. FIGS. 2 and 3 show exemplary messages according to the invention. For example, the message may be an SMS message 202 or an email message 302. The link is configured to cause execution of the script on the second device. The script is configured to cause the second device 108 to retrieve 106 the survey or review from the server 104 and store it in a clipboard of the second device 108. The link may contain a reference to the identifying information or other unique identification, providing the server 104 with sufficient information to retrieve the survey or review submitted by the user at the first device 100.

The user is also prompted, in the message, to access the survey or review in order to post 110 the survey or review on a review platform or website 112. The prompt may be a link to a review platform or website 112. The link to the review platform or website may be the same link which causes execution of the script.

After the user has followed the link, the user's survey or review responses are located in a clipboard of the second device 108. The user may then use a “paste” function of the second device 108 to copy the content of the survey or review stored in the clipboard of the second device into the review platform or website.

Reiterating in the context of the foregoing example of a medical office, a patient may be asked, upon completion of a visit to the medical office, if they would like to complete a survey or review of the doctor, the medical office, and/or medical care received during the visit. If the patient consents to complete the survey or review, the patient may be given a tablet or directed to a computer on which the patient can complete the survey or review, and the patient's responses are stored on a server. As part of the survey or review, the patient is asked for personal contact information and if the patient subscribes to any review platform or website. If the patient indicates that they are subscribed to a review platform or website, the patient may be asked to publish his or her responses the survey or review on the review platform or website to which the patient is subscribed.

To avoid the patient having to retype his or her responses, the server sends a message to the patient, using the provided contact information, containing a link to complete the survey or review on the review platform or website. Following the link causes a script to run on the patient's device which retrieves the patient's responses from the server and stores them in a clipboard of the patient's device. The patient can then use the “paste” function of the device to enter the responses stored in the clipboard into the review platform or website without having to retype each response.

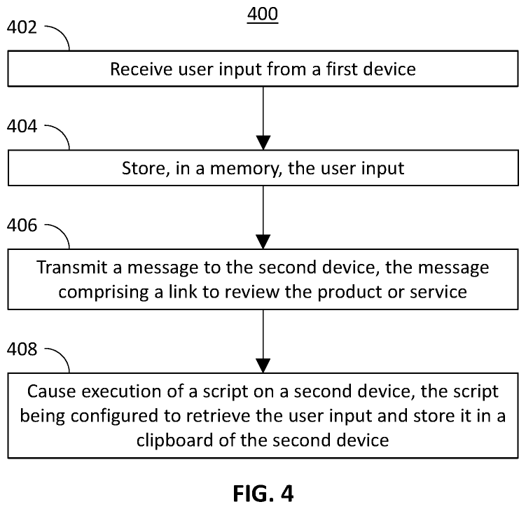

A method according to an embodiment of the invention is diagrammed in FIG. 4. As described in more detail below, method 400 enables a user to post a survey or review on a review platform or website (e.g., review platform or website 112). According to this embodiment, the second device, or an application thereon, may be controlled by the system. Therefore, in this embodiment, the system directly causes the second device to perform certain actions through use of a script.

Method 400 begins at 402 of method 400, wherein the system receives user input from a first device (e.g., device 100). As noted above, the device may be a personal computer or tablet computer, which is provided for completing surveys or reviews, but any suitable type of input device could be used. The user input may be received using Hypertext Transfer Protocol, File Transfer Protocol, Simple Mail Transfer Protocol, or any other suitable data transfer protocol or method.

At 404, the system stores the received user input in a memory. For example, the system may store the received user input in a memory buffer (e.g., RAM) or a hard drive of server 104. The user input may be stored in a database, flat file, or other suitable data structure. In some embodiments, the user input may include an identifier associated with the user, such as an email address or mobile telephone number. The user input may be stored in association with the identifier. Storing user input in associated with such unique identifiers may facilitate later retrieval of the user input.

At 406, the system transmits a message to the second device 108. The message may be an SMS message, an MMS message, an email, or any other suitable type of message. The message contains a link for the user to complete their survey or review. For example, server 104 transmits a message to the second device 108. Server 104 directs transmission of the message based on identifying information contained within the survey or review received from the first device 100. For example, the identifying information may contain a mobile telephone number, and the message may be an SMS or MMS message 202 addressed to the mobile telephone number. Alternatively or additionally, the identifying information may contain an electronic mail address, and the message may be an electronic mail message 302 addressed to the electronic mail address.

At 408, in response to the user following the link, the system causes execution of a script on a second device 108, wherein the script is configured to retrieve 106 the user input and store it in a clipboard of the second device 108. The clipboard may be a temporary storage area of the second device 108, which may be capable of storing one set of data at a time. Upon accessing the review platform or website 112, the user may access a “paste” function of the second device 108, which copies data from the clipboard into an input field of the review platform or website 112.

In some embodiments, the second device 108 can be directly controlled by the system. For example, the medical office may have a proprietary application which the user has installed on the second device 108, allowing the system to control certain functions of the second device 108. In such embodiments, the system transmits to the second device a message, such as a push notification, or command via the proprietary application. The message or command is configured to retrieve the user's survey or review from server 104, store it in a clipboard of the second device 108, and cause the second device 108 to navigate to launch review platform or website 112.

In some cases the survey or review may be conducted primarily for internal use by the medical office, and users may not be required to publish their responses. However, the medical office may wish users to publish their responses for business purposes, such as to increase market visibility. The survey or review may therefore ask the user to identify any review platforms or websites with which the user has an account. The message containing the link is only sent to users who indicated that they are subscribed to a review platform or website (e.g., review platform or website 112).

In some embodiments, only free text responses are retrieved from the server 104 and stored in the clipboard of the second device 108. The user pastes the responses from the clipboard into the appropriate free text fields on the review platform or website 112 without having to retype the responses, while still having to respond to yes/no and rating questions which may be included in the survey or review.

In some embodiments, the script further includes an intelligent paste function. For example, the script retrieves the user's responses to each question in the survey or review from the server 104 separately, or as a set of comma-separated values. Upon launching the review platform or website 112, the script may extract and paste the user's responses to each question from the clipboard into the appropriate field. As another example, the script retrieves only free text responses from the server 104, and pastes the free text responses in the appropriate fields, leaving the user to complete only yes/no and rating questions.

Thus it is seen that a system and method for reviewing a product or service is provided. One skilled in the art will appreciate that the present invention can be practiced by other than the described embodiments, which are presented for purposes of illustration, and not of limitation, and the present invention is limited only by the claims which follow.

What is claimed is:

1. A method for reviewing a product or service, said method comprising:
receiving user input from a first device, said user input comprising a review of said product or service;
storing, in a memory, said user input; and
causing execution of a script on a second device, said script being configured to:
retrieve, from said memory, said user input; and
store said user input in a clipboard of said second device.

2. The method of claim 1, wherein said memory comprises a database of reviews of said product or service.

3. The method of claim 1, further comprising, after said storing in said memory said user input, transmitting a message to said second device, said message comprising a link to review said product or service.

4. The method of claim 3, wherein said message is an SMS message.

5. The method of claim 3, wherein said message is an MMS message.

6. The method of claim 3, wherein said message is an electronic mail message.

7. The method of claim 3, wherein said link is configured to cause said second device to execute said script.

8. The method of claim 3, wherein said user input further comprises an identifier associated with said user, and wherein transmitting said message to said second device is based on said identifier associated with said user.

9. The method of claim 8, wherein said identifier associated with said user is a telephone number.

10. The method of claim 8, wherein said identifier associated with said user is an electronic mail address.

11. An apparatus for reviewing a product or service, said apparatus comprising:
memory configured to store reviews of said product or service;
a first device that accepts user input comprising a review of said product or service;
first control circuitry configured to:
receive, from said first device, said user input;
store, in said memory, said user input; and
second control circuitry configured to cause execution of a script on a second device, said script being configured to:
retrieve, from said memory, said user input; and
store said user input in a clipboard of said second device.

12. The apparatus of claim 11, wherein said memory comprises a database of reviews of said product or service.

13. The apparatus of claim 11, wherein said first control circuitry is further configured to transmit a message to said second device, said message comprising a link to review said product or service.

14. The apparatus of claim 13, wherein said message is an SMS message.

15. The apparatus of claim 13, wherein said message is an MMS message.

16. The apparatus of claim 13, wherein said message is an electronic mail message.

17. The apparatus of claim 13, wherein said link is configured to cause said second control circuitry to execute the script.

18. The apparatus of claim 13, wherein said user input further comprises an identifier associated with said user, and wherein said control circuitry configured to transmit said message to said second device is further configured to transmit said message based on said identifier associated with said user.

19. The apparatus of claim 18, wherein said identifier associated with said user is a telephone number.

20. The apparatus of claim 18, wherein said identifier associated with said user is an electronic mail address.

21. A method for reviewing a product or service, said method comprising:
receiving user input from a first device, said user input comprising a review of said product or service;
storing, in a memory, said user input;
retrieving, at a second device, from said memory, said user input; and
storing said user input in a clipboard of said second device.

22. The method of claim 21, wherein said memory comprises a database of reviews of said product or service.

23. The method of claim 21, further comprising, after said storing in said memory said user input, transmitting a message to said second device, said message comprising a link to review said product or service.

24. The method of claim 23, further comprising accessing said link, wherein said link is configured to cause said retrieving said user input and said storing said user input in said clipboard of said second device.

25. The method of claim 23, wherein said message is an SMS message.

26. The method of claim 23, wherein said message is an MMS message.

27. The method of claim 23, wherein said message is an electronic mail message.

28. The method of claim 23, wherein said user input further comprises an identifier associated with said user, and wherein transmitting said message to said second device is based on said identifier associated with said user.

29. The method of claim 28, wherein said identifier associated with said user is a telephone number.

30. The method of claim 28, wherein said identifier associated with said user is an electronic mail address.

31. An apparatus for reviewing a product or service, said apparatus comprising:
memory configured to store reviews of said product or service;
a first device that accepts user input comprising a review of said product or service, said first device having a first control circuitry configured to:
receive, from said first device, said user input; and
store, in said memory, said user input; and
a second device having second control circuitry configured to:
retrieve, from said memory, said user input; and
store said user input in a clipboard of said second device.

32. The apparatus of claim 31, wherein said memory comprises a database of reviews of said product or service.

33. The apparatus of claim 31, wherein:
said first control circuitry is further configured to transmit a message to said second device, said message comprising a link to review said product or service; and
said second control circuitry is further configured to receive said message.

34. The apparatus of claim 33, wherein said second control circuitry is further configured to access said link, wherein said link is configured to cause said second control circuitry to retrieve said user input and store said user input in said clipboard of said second device.

35. The apparatus of claim 33, wherein said message is an SMS message.

36. The apparatus of claim 33, wherein said message is an MMS message.

37. The apparatus of claim 33, wherein said message is an electronic mail message.

38. The apparatus of claim 33, wherein said user input further comprises an identifier associated with said user, and wherein said control circuitry configured to transmit said message to said second device is further configured to transmit said message based on said identifier associated with said user.

39. The apparatus of claim 38, wherein said identifier associated with said user is a telephone number.

40. The apparatus of claim 38, wherein said identifier associated with said user is an electronic mail address.
